(19) United States
(12) Patent Application Publication
(10) Pub. No.: US 2006/0183019 A1
(43) Pub. Date: Aug. 17, 2006

(54) Adhesive for use in an electrochemical cell

(75) Inventors: Gregory J. Davidson, Oregon, WI (US); Andreas Winardi, Madison, WI (US); Karthik Ramaswami, Middleton, WI (US); Erik Mortensen, Sun Prairie, WI (US)

Correspondence Address: SENNIGER POWERS, ONE METROPOLITAN SQUARE, 16TH FLOOR, ST LOUIS, MO, 63102, US

(73) Assignee: Rovcal, Inc., Madison, WI (US)

(21) Appl. No.: 11/058,665

(22) Filed: Feb. 15, 2005

(51) Int. Cl. H01M 2/18; H01M 2/16; H01M 2/08; H01M 10/26

(52) U.S. Cl. 429/142; 429/144; 429/185; 429/254; 429/255; 429/206

(57) ABSTRACT

Electrochemical cells comprising an anode, a cathode, a container, and a separator are disclosed. At least a portion of the separator is covered by an adhesive material that is bonded to the container or a sealing assembly. The adhesive material provides a mechanical bond between the separator and the container or sealing assembly, and acts to minimize or prevent physical and chemical transport from the anode to the cathode and vice versa. The adhesive material provides a means to utilize thin separators in an electrochemical cell without compromising the shelf life or reliability of the cell. The inhibition of the species migration with the electrochemical cell substantially minimizes or eliminates shorting within the cell or the degradation of shelf life of the cell by limiting the migration of soluble species that can foul one or both electrodes.

### FIELD OF THE INVENTION

The present invention generally relates to an electrochemical cell comprising an anode, a cathode, and a separator. More specifically, the present invention relates to an electrochemical cell comprising an adhesive material in contact with at least a part of the separator. The adhesive material effectively minimizes physical and chemical transport between the anode and the cathode compartments of the electrochemical cell while also reducing the potential for internal shorting.

### BACKGROUND OF THE INVENTION

Electrochemical cells, commonly known as “batteries,” are used to power a wide variety of devices used in everyday life. For example, devices such as radios, toys, cameras, flashlights and hearing aids all ordinarily rely on one or more electrochemical cells to operate. Generally, the terms “battery” or “electrochemical cell” are used to describe the connection of one or more electric cells together to convert chemical energy into electrical energy.

Electrochemical cells may be configured as elongate cylindrical cells, such as standard AA-, AAA-, C-, and D-sized batteries, which are commonly used in flashlights, portable radios, and toys. Electrochemical cells may also be configured as flat cells, such as prismatic cells and button cells, which are commonly used in watches, hearing aids, and in cordless and cellular telephones.

Conventional primary alkaline electrochemical cells include a negative electrode (anode), a positive electrode (cathode), an electrolyte, a separator, a sealing assembly, a positive current collector, and a negative current collector. These components are typically housed in a battery container, which also functions as the positive current collector, having an open end. The most commonly used cathode of conventional alkaline electrochemical cells comprises manganese dioxide and a conducting carbonaceous material, such as, for example, synthetic graphite, natural graphite, expanded graphite, and mixtures thereof, together with a polymeric binder and other additives. Alkaline electrochemical cells may also comprise other cathode active materials such as NiO, NiOOH, oxides of copper, or mixtures thereof. In some alkaline electrochemical cells, the cathode mixture is compressed into one or more annular rings and stacked in the battery container. Alternatively, the mixture may be extruded directly into the battery container.

The anode of conventional alkaline electrochemical cells comprises zinc or zinc alloy particles of various dimensions and shapes along with gelling agents, such as carboxymethylcellulose (CMC), and other additives, such as surfactants. Electrical connection to the anode is achieved by inserting an elongate metal rod, commonly referred to as a negative current collector, pin, or nail, placed in electrical contact with the gelled anode active material. The negative current collector may be made of brass or other suitable metal and extends through a resilient and electrically non-conductive sealing assembly that closes the open end of the battery container, sealing the electrochemical cell components within. The top end of the negative current collector protrudes above the sealing assembly for physical and electrical connection to an electrically conductive negative terminal plate, while the primary length of the negative current collector is inserted into the anode active material within the cell.

In the conventional alkaline electrochemical cell, the cathode is typically formed against the interior surface of the battery container, while the anode is generally centrally disposed in a cavity formed in the center of the cathode. The converse is also possible, where the anode surrounds an inner core of cathode material. To reduce internal resistance and enhance high current discharge, the interior surface of the container is generally coated with a conducting agent, typically comprising carbon. A tubular separator is located between the cathode and the anode. The separator typically extends from the bottom of the battery container to a terminal end extending slightly outward from between the anode and cathode, particularly prior to the cell being closed. The fundamental purpose of the separator is to separate the cathode and anode portions of the alkaline electrochemical cell and prevent an internal short circuit that would compromise the performance or shelf life of the cell. The separator is commonly a multi-layered, permeable, non-woven fibrous material wetted with an alkaline electrolyte. The separator maintains a physical dielectric separation between the anode and cathode, but still allows for the transport of ions and electrolyte between the electrode materials. The separator also acts as a wicking medium for the alkaline electrolyte solution, typically potassium hydroxide or sodium hydroxide, which promotes ionic or electrolytic transport and conductivity. If the anode and cathode come into physical contact with each other in any way, an active chemical reaction occurs, resulting in an internal electrical short circuit or other reduction in the useful electrochemical capacity of the electrochemical cell.

Conventional separators generally require multiple overlapping layers to prevent unwanted electrical conduction between the cathode and the anode. Where a single layer of separator material is used, openings that are commonly present in the material permit the presence or formation of an undesirable conductive path between the cathode and the anode. Alternatively, the use of multiple or thicker layers of separator material typically increases the volume necessary in the electrochemical cell for the separator component, leaving less room for the active electrochemical materials, and thus potentially reducing the life of the cell. The thicker separator materials also tend to increase the amount of ionic resistance between the anode and the cathode, limiting the high rate discharge performance of the electrochemical cell. There is a need to balance the need for thinner separators, which can provide better performance and more available volume for actives, and the need for greater reliability and long shelf life with minimal risk of shorting. As such, thinner separators coupled with a cell design and process than can provide all of these desirable attributes are highly sought after.

Upon closing the cell, the sealing assembly is compressed against the terminal end of the separator, often causing the terminal end of the separator to fold slightly, or even to fold over upon itself, so that the terminal portion of the separator is in contact with the sealing assembly in such a manner as to inhibit the electrode materials from being carried over the terminal end of the separator between the cathode and the anode compartments. Generally, the sealing assembly is formed of a material which is inert to the alkaline electrolyte contained in the cell and the overall environment of the cell itself. The sealing assembly must also be flexible and be able to maintain a proper seal during extended periods of use or storage. Materials such as nylon, polypropylene, ethylene-tetrafluoroethylene copolymer and high density polyethylene are known in the art as suitable sealing assembly materials. While these sealing assemblies help keep the cathode and the anode from contacting each other, electrical shorting and loss of battery life may still occur due to the separation of the sealing assembly from the separator during manufacturing, distribution, handling, or use.

As a result of the deficiencies in the thicker separator materials, various thin film and membrane separator materials have also been developed. These separator materials function in a similar manner to the thicker separator materials. However, effectively incorporating such materials in cylindrical batteries while maintaining the reliability from shorting is a challenge as compressing these thin film and membrane separator materials against the sealing assembly in the same manner as the conventional thick separators often fails to completely prevent contact between the cathode and the anode during manufacturing, distribution, handling, or use. Additionally, if the film separator does not absorb and hold all of the requisite electrolyte, the cell will likely contain more free electrolyte than a cell with a conventional non-woven separator system. Compared to a conventional cell where substantially all of the electrolyte is immobilized due to absorption by the separator, a cell with more free electrolyte has a greater risk of internal shorting due to the increased likelihood of fine electrode particles becoming entrained in the free liquid and carried over to the other electrode.

Electrochemical cells of the type typically used by consumers must be able to withstand the physical rigors associated with manufacturing processes, distribution, consumer handling, or other forces. These forces can dislodge the sealing assembly from the separator, resulting in the potential for contact between the cathode and the anode that may result in an internal electrical short circuit or other reduction in the useful electrochemical capacity of the electrochemical cell.

Therefore, it would be desirable to provide a means for improving the seal between the separator and the seal assembly to reduce the potential for internal shorting between the anode and cathode. Additionally, if the cathode comprises active materials that have a tendency to generate anode fouling species as is the case, for example when using oxides of copper or silver, or if the cathode comprises sulfur compounds, there is an additional need to effectively limit the migration of such anode fouling species from the cathode to the anode compartment. A tubular separator with a seam seal and a bottom seal in combination with conventional cell sealing methods may not be adequate to prevent transport over the top of the separator. More specifically, it would be desirable to provide an adhesive material for mechanically bonding the sealing assembly to the separator, and/or mechanically bonding the separator to the inner surface of the battery container. The adhesive would help to prevent internal electrical short circuits or other reduction in the useful electrochemical capacity of the electrochemical cell caused by undesirable contact between the cathode and the anode. It would also be desirable to provide an adhesive for mechanically bonding components in an electrochemical cell which would help to prevent any undesirable physical and chemical transport of cathode and/or anode active materials over or around the separator. Additionally, it would be desirable to provide an adhesive possessing the above-mentioned properties that is also capable of withstanding the highly alkaline environment typically present in an alkaline electrochemical cell such that the adhesive is substantially stable over long periods of time.

### SUMMARY OF THE INVENTION

The present invention provides an electrochemical cell comprising an anode, a cathode, a container, a separator, and an adhesive material. The adhesive material, which may be attached to the container or to a sealing assembly as described herein, covers at least a part of the separator that extends above the anode/cathode interface such that physical and/or chemical transport over the separator is significantly reduced or eliminated and the performance, shelf life, and reliability of the electrochemical cell is improved. The adhesive materials utilized in the electrochemical cells of the present invention to mechanically bind the separator will not substantially interact with, or be degraded by, the highly alkaline electrolytes present in the anode.

As such, the present invention is directed to an electrochemical cell comprising an anode, a cathode, a container containing the cathode and the anode, a separator disposed in the container, and an adhesive material. The separator comprises a first portion and a second portion, the first portion being disposed generally between the cathode and the anode and the second portion extending longitudinally outward of the cathode and the anode. The adhesive material covers at least a part of the second portion of the separator and is capable of minimizing physical and/or chemical transport over the second portion of the separator.

The present invention is further directed to an electrochemical cell comprising an anode, a cathode, a container containing the cathode and the anode, a separator disposed in the container, a negative current collector disposed in the container and in contact with the anode, and an adhesive material. The separator comprises a first portion and a second portion, the first portion being disposed generally between the cathode and the anode and the second portion extending longitudinally outward of the cathode and the anode. The adhesive material is in contact with the container and covers at least a part of the second portion of the separator, and is capable of minimizing physical and/or chemical transport over the second portion of the separator.

The present invention is further directed to an electrochemical cell comprising an anode, a cathode, a container containing the cathode and the anode, a sealing assembly, a separator, a negative current collector disposed in the container and in contact with the anode, and an adhesive material. The separator comprises a first portion and a second portion, the first portion being disposed generally between the cathode and the anode and the second portion extending longitudinally outward of the cathode and the anode. The adhesive material is in contact with the sealing assembly and covers at least a part of the second portion of the separator, and is capable of minimizing physical and/or chemical transport over the second portion of the separator.

### BRIEF DESCRIPTION OF THE DRAWINGS

FIG. 1 illustrates a cross section of an electrochemical cell in an open configuration including a cathode, an anode, and a sealing assembly.

FIG. 2 illustrates a cross section of an electrochemical cell in an open configuration including an adhesive material positioned according to one embodiment of the present invention.

FIG. 3 illustrates a cross section of an electrochemical cell in an open configuration including an adhesive material positioned according to one embodiment of the present invention.

FIG. 4 illustrates a cross section of an electrochemical cell in a closed configuration.

### DETAILED DESCRIPTION OF THE INVENTION

The present invention is generally directed to an electrochemical cell. More specifically, the present invention is directed to an electrochemical cell comprising a cathode, an anode, a container containing the cathode and the anode and a separator disposed in the container comprising a first portion and a second portion, the first portion being disposed generally between the cathode and the anode and the second portion extending longitudinally outward of the cathode and the anode. The electrochemical cells of the present invention further comprise an adhesive material covering at least a part of the second portion of the separator, the adhesive material being capable of minimizing physical and/or chemical transport over the second portion of the separator. Surprisingly, it has been found that the adhesive materials as described herein are able to withstand the highly alkaline environment of the cell without substantial degradation and form a reliable mechanical bond with the separator and reduce the chemical interaction between the cathode and the anode.

Specific components and embodiments of the present invention are described in further detail below. As used herein, the term “physical transport” refers to the movement of liquid and/or particles from one area of an electrochemical cell to another area of an electrochemical cell. As used herein, the term “chemical transport” refers to the movement of liquid and/or dissolved chemical species through a material, such as an adhesive material or a separator material, from one area of an electrochemical cell to another area of an electrochemical cell. In the presence of anode-fouling soluble species in the cathode, the use of a separator comprising an appropriate barrier material is highly desirable. An appropriate material would be capable of effectively limiting the transport of the soluble species to the anode. Furthermore, it would need to be configured such that substantially all fluid communication between the anode and the cathode occurs through the material. To minimize dissolved species from being transported over the top of the separator, as adhesive material must also be capable of effectively limiting transport of such chemical species over it or through it.

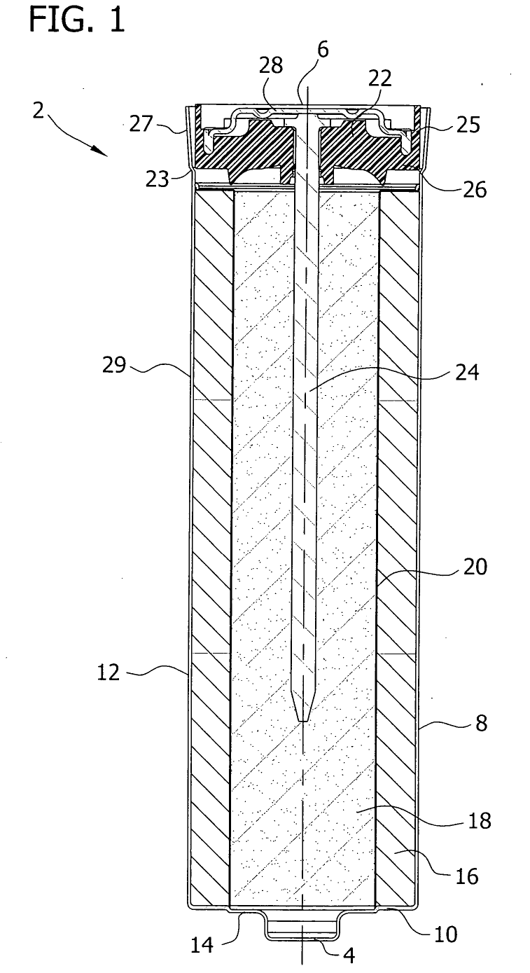

Referring now to the drawings, and in particular to FIG. 1, a conventional electrochemical cell is shown in the form of a AA-size cylindrical cell battery and is generally indicated at 2. It is contemplated, however, that the electrochemical cell of the present invention has application to other sized batteries (e.g., A-, AAA-, C- and D-), as well as to non-cylindrical cells, such as flat cells (prismatic cells and button cells). The cylindrical cell configuration shown in FIG. 1 has a positive terminal 4, a negative terminal 6, and a positive current collector in the form of an electrically conductive cylindrical container 8. In the illustrated embodiment, a single piece formed container 8 may be of drawn steel having a closed bottom formed by an end wall 10 and a cylindrical side wall 12 formed as one piece with the end wall 10. The positive terminal 14 is thus defined by the end wall 10 of the metal container 8 in the illustrated embodiment. In alternative embodiments the end wall may be flat and have a positive terminal plate (not shown) attached thereto as by welding to define the positive terminal 14 without departing from the scope of this invention. The opposite end of the container 8 is generally open. As used herein the term “side wall” refers not only to a wall like the illustrated cylindrical wall 12 having a single, continuous curve, but also to side walls (not shown) having other shapes including those formed from multiple flat wall sections.

The term “longitudinal”, as used herein, refers to the general direction extending from one end of the container 8 to the other, regardless of whether the greatest dimension of the container is in the longitudinal direction. The terms “lateral,” “transverse” and “radial” refer to a general direction extending perpendicular to the longitudinal direction so as to extend through the side wall 12 of the container 8. Also, throughout the various drawings the electrochemical cells are illustrated in a generally vertical orientation, with the positive terminal at the bottom and the negative terminal at the top. It is to be understood that the use of terms herein such as top, bottom, upper and lower, are in reference to positions along the longitudinal direction of the cell 2 (e.g., of the container 8), while the use of terms such as inner and outer are in reference to positions along the transverse or radial direction.

Contained in the container is a cathode 16 comprised of one or more annular rings formed of a suitable cathode material which defines an open center along the longitudinal direction of the container. The cathode 16 suitably has an outer diameter that is slightly greater than the inner diameter of the container side wall 12 to provide a tight fit upon insertion of the cathode into the container 8. A coating, suitably carbon, may be applied to the inner surface of the container side wall 12 to enhance electrical contact between the cathode 16 and the container 8. One example of a particularly suitable cathode 16 comprises an oxide of copper and is disclosed in co-assigned U.S. patent application Ser. No. 10/914,934, the entire disclosure of which is incorporated herein by reference.

Copper oxide (CuO) is known as a high capacity (e.g., about 337 mAh/g for a 1-electron reduction and 674 mAh/g for a 2-electron reduction) cathode material with the potential to significantly increase service life compared to some commercially available alkaline cells. One issue arises as a result of the operating voltage of the copper oxide being too low for applications requiring open circuit voltages above 1.1V or closed circuit voltage above 1.0V at reasonable current drains. Various alternatives enable the operating voltage increase of a copper oxide containing cell.

One approach is to provide a cathode active material that comprises a physical mixture of an oxide of copper with another metal oxide. A second approach includes compounding or complexing a plurality of components to synthesize new cathode active materials that comprise copper and at least one other metal or non-metal. A third general approach is to provide a cathode having copper oxide mixed or combined in various ways with at least one additional material such that the Gibbs Free Energy of the overall reaction with zinc is increased as a result of displacement reactions between (for example) copper oxide and the additional material, such as copper sulfide. It is further recognized that various combinations of the described general approaches may be used to provide the desired result.

In the first approach, chemical components having the desirable physical characteristics (e.g., particle size, surface area, etc.) for use in a cathode can be physically mixed to homogeneity using standard processing methods known to those having ordinary skill in the art. In use, such a physical cathode mixture transitions from the discharge behavior of the higher voltage oxide to that of the oxide of copper. Supplementary metal oxide additives to the oxide of copper can be chosen from the group of generally known positive electrode materials that independently provide higher operating voltages vs. zinc in the initial portion of discharge than does the oxide of copper. Suitable examples of positive electrode materials can include, but are not limited to, manganese dioxide (EMD, CMD, NMD, and mixtures thereof), NiO, NiOOH, Cu(OH)₂, Cobalt Oxide, PbO₂, AgO, Ag₂O, Ag₂Cu₂O₃, CuAgO₂, CuMnO₂, and suitable combinations thereof.

Manganese is used as an example herein since it is currently the most widely used cathode active material. Manganese oxide is therefore used in combination with copper oxide to increase the initial portion of the discharge curve of a copper oxide-containing cathode while maintaining the longer service life provided by copper oxide. Similar methods can be utilized using other elements such as Ni, Co, Pb, Ag, etc. to enhance the voltage in the initial portion of the discharge curve as desired. Generally, the higher the oxidation state of an active material, the higher the discharge voltage.

In the second general approach, a higher operating voltage than pure copper oxide, and a smoother and more continuous transition than in the preceding method, can be obtained by solution phase chemical compounding or synthesis using soluble cationic elements to produce mixed oxide compounds or complexes existing in one or more phases. Suitable elements can include, but are not limited to, Mn, Ni, Co, Fe, Sn, V, Mo, Pb, or Ag, or combinations thereof. Such mixed oxide compounds, combinations of mixed oxide compounds, or mixtures comprising mixed oxides, may also be produced via solid state synthesis reactions at appropriate temperatures, as one skilled in the art will readily appreciate.

In one suitable embodiment of the second general approach, the general formula of a copper based mixed oxide material is MxCuyOz, wherein M is any suitable element, as noted above, and wherein 1=x=5, 1=y=5 and 1=z=20. Compounds having AMxCuyOz as a general formula, wherein A can be, e.g., Li, Na, K, Rb, Cs, Ca, Mg, Sr and Ba, can also be designed for use as cathode active materials.

In the third general approach, supplementary additives can be chosen for combining, from elements or compounds that have a lower discharge voltage than copper oxide, but which, in combination with copper oxide, produce a higher discharge voltage than either constituent alone. When the reaction kinetics are suitably rapid, the discharge voltage of these couples also follows the same trend as the open circuit voltage. Examples of such materials may include, but are not limited to, elemental sulfur, selenium, tellurium, sulfides, selenides, tellurides, and iodates such as CuS, Ag₂S, ZnS, B₂S₃,SnS, FeS, Fe₂S₃, CoS, NiS, CuSe, CuTe, CuAgS, CuAg₃S, and suitable compounds and mixtures thereof.

The cathode can also be provided with an agent that may reduce anode-fouling soluble species from migrating from the cathode toward the anode by interacting with the soluble species. Agents such as polyvinyl alcohol, activated carbon, natural and synthetic clays and silicates such as Laponite®, etc. have shown an ability to adsorb or block ionic species, and may suitably be introduced into the cathode, anode, separator, or electrolyte.

In light of the foregoing, however, it is understood that the cathode may be constructed of copper oxide, manganese dioxide or any other suitable cathode active materials or combinations thereof without departing from the scope of this invention.

Also contained in the container is an anode 18 located on the inner diameter of a separator 20 so that the separator physically separates the anode 18 from the cathode 16. The anode 18 can be formed in any suitable manner, and may suitably comprise a mixture including an anode metal (e.g., zinc) provided as a powder, an aqueous alkaline electrolyte and a gelling agent. Examples of suitable anode 18 formulations are discussed in co-assigned U.S. Pat. No. 6,040,088, the entire disclosure of which is incorporated herein by reference. Additional electrolyte (not shown in the Figures) may be added to the container 8 to partially wet the anode 18, the cathode 16 and the separator 20. Suitable electrolytes include potassium hydroxide and sodium hydroxide in an alkaline battery, but other compositions can be used without departing from the scope of the present invention.

In a specific embodiment, a high capacity anode-formulation is provided for use in alkaline cells. Cathodes of conventional alkaline cells, for example cathodes whose cathode active ingredient is MnO₂, consume more water by the cathodic reaction than is produced by the anodic reaction (i.e., the reaction of zinc anode and electrolyte). Hence the total cell reaction, as represented, consumes water as shown below and are thus said to be “water consuming”:
Zn+2MnO₂+H₂O→ZnO+2MnOOH

The zinc anodes of conventional alkaline cells are thus generally limited to a concentration (loading) of zinc by weight below 70% in the anode because higher zinc loadings will not discharge efficiently as the anode would not contain sufficient quantities of electrolyte to properly sustain the water consuming reaction in the cathode. Furthermore, high zinc loadings with conventional particle size distributions result in higher mass transfer polarization, believed to be due to the low porosity of these anodes leading to early anode passivation and premature failure.

The anode provided in accordance with this embodiment is usable in an electrochemical cell whose cathode consumes less water than conventional alkaline manganese dioxide cells, and achieves a higher discharge efficiency compared to conventional cells. Because the copper oxide and mixed copper oxide active materials of the cathode are low-water-consuming compared to manganese dioxide, the amount of electrolyte required in the anode is reduced relative to a conventional zinc manganese dioxide alkaline cell. The low-water consuming reaction advantageously permits an increase in zinc loading in the anode and thereby facilitating a longer cell service life.

It has been determined that a CuO-containing cathode is one example of a cathode that consumes less water than alkaline manganese dioxide cells. A zinc/air battery cathode is an example wherein the reaction does not consume water and the anode operates efficiently at anode zinc loadings of 68% to 76% by weight relative to the total weight of the anode (including electrolyte), which is significantly higher than in a conventional alkaline manganese cell.

An anode thus constructed can be “drier” than conventional electrochemical cells, meaning that the anode has a higher loading of zinc particles that can be efficiently discharged with reduced electrolyte concentrations given the following anodic cell reaction:
Zn+4OH−→Zn(OH)₄²⁻+2e−

Without being bound to a particular theory, it is believed that in conventional alkaline batteries, the depletion of hydroxide ions can become prominent during medium and high continuous discharge rates (e.g., greater than 250 mA for a size AA cell) and induce depressed cell performance due to anode failure in these cases. Furthermore when the electrolyte is saturated with zincate Zn(OH)₄²⁻ produced in the above reaction, the zincate precipitates to form zinc oxide which, in turn, passivates the zinc anode, thereby lowering cell performance. Conventional zinc powders contain particles having a wide distribution of particle sizes ranging from a few microns to about 1000 microns, with most of the particle size distribution ranging between 25 microns and 500 microns. Therefore, in order to achieve proper discharge of such conventional zinc powders, a potassium hydroxide concentration above 34% is conventionally used and necessary. A potassium hydroxide concentration less than 36% (for example between 25% and 34% potassium hydroxide concentration) is desirable, using principles of the present invention while avoiding premature anode passivation that would occur in a conventional cell

A narrow particle size distribution as described in more detail below allows the use of electrolyte concentrations significantly lower than in conventional alkaline batteries. This in turn further favors lower copper solubility into the electrolyte, better wetting of the cathode surface and assists the discharge efficiency of the cathode.

Various aspects of the present invention recognize that the particle size distribution of the zinc plays a role in enhancing the effectiveness of discharge in a low zinc loading anode, as is described in more detail below. In particular, several particle size distributions have been identified that allow the use of the lower electrolyte concentrations while providing the necessary anode porosity for an efficient discharge at high zinc loadings.

Physical modifications to the anode can also improve cell service life, either alone or in combination with chemical modifications noted above. For example, one can efficiently discharge cells having an advantageously lower concentration of hydroxide ions in the electrolyte than can be used in conventional cells by reducing diffusion resistance for the hydroxide ions. This can be accomplished, for example, by adjusting the zinc particle size distribution to provide in the anode a narrow distribution of similar zinc particle sizes, thereby enhancing porosity (diffusion paths) for the hydroxide ion transport. In addition to improving mass transport in the gelled anode matrix, the particle size distributions also provide increased porosity, which allows for less precipitation of ZnO on the zinc particle surface, thereby delaying anode passivation compared to the particle size distributions typically found in conventional cells. This approach is effective for use in the anodes of various aspects of the invention and can be used alone or in combination with other improvements disclosed herein.

Similarly, a suitable zinc particle size distribution is one in which at least about 70% of the particles have a standard mesh-sieved particle size within a 100 micron size range and in which the mode of the distribution is between about 100 microns and about 300 microns. It is desirable that 70% of the particles be distributed in a size distribution range even more narrow than 100 microns, for example 50 microns or even 40 microns or less.

A suitable gelled anode as described herein comprises a metal alloy powder (desirably an alloyed zinc powder), a gelling agent and an alkaline electrolyte. One skilled in the art can readily select a suitable zinc powder (alloyed with In, Bi, Ca, Al, Pb, etc). As used herein, “zinc” refers to a zinc particle that may include an alloy of zinc as is well known to one skilled in the art. Another aspect of the electrochemical cells described herein is that the anode may contain little or no mercury (e.g., less than about 0.025% by weight). It is noted that known gelling agents other than the desirable sodium polyacrylate gelling agent are suitable for use in various aspects of the present invention. Such gelling agents include carboxymethyl cellulose, crosslinked-type branched polyacrylate acid, natural gum, and the like.

In addition to the foregoing, the anode may also comprise a surfactant such as, for example, an oxazoline-type surfactant, which can be a fatty oxazoline surfactant, as an additive in the alkaline electrochemical cell anode. One example of an alkaline electrochemical cell comprising an anode with an oxazoline surfactant additive is disclosed in co-assigned U.S. patent application Ser. No. 10/020,685, the entire disclosure of which is incorporated herein by reference. A preferred oxazoline surfactant for use in the electrochemical cell of the present invention is ethanol, 2,2′-[(2-heptadecyl-4(5H)-oxazolydine)bis (methyleneoxy-2,1-ethanedyloxy]bis, commercially available as Alkaterge™ T-IV (Angus Chemical, Northbrook, Ill.).

Additionally, the electrochemical cell of the present invention comprises a seal or sealing assembly 22 constructed to broadly define an apparatus for substantially sealing a portion of the separator 20 to inhibit contamination between the anode and the cathode. The sealing assembly 22 is generally disk-shaped and comprises an annular radially inner portion (broadly, a first sealing member of the sealing assembly) including a central hub through which the negative current collector 24 extends, and an annular radially outer portion (broadly, a second sealing member of the sealing assembly).

Generally, the sealing assembly 22 is of single-piece construction, although a sealing assembly comprising more than one piece may also be used. For example, the sealing assembly 22 may be molded of nylon 6,6 which has been found to be inert to the electrolyte (e.g., potassium hydroxide) contained in the anode 18, and yet also sufficiently deformable upon compression to function as a seal against the side wall 12 of the container 8. It is contemplated that the sealing assembly 22 may alternatively be formed of other suitable materials, including without limitation polyolefin, polysulfone, polypropylene, filled polypropylene (e.g., talc-filled polypropylene), sulfonated polyethylene, polystyrene, impact-modified polystyrene, glass filled nylon, ethylene-tetrafluoroethylene copolymer, high density polypropylene and other plastic materials. One particular example of a suitable glass filled nylon material for use in forming the sealing assembly is disclosed in co-assigned U.S. patent application Ser. No. 10/914,934, the disclosure of which is incorporated herein by reference to the extent that it is consistent.

The outer portion 25 of the sealing assembly 22 is generally L-shaped in cross section with a radially outer vertical leg of the “L” facing the interior of the side wall 12 of the container 8 upon assembly of the cell 2. A horizontal leg 26 of the “L” forms an annular shoulder on which negative terminal plate 28 is supported.

FIG. 1 particularly illustrates the cell 2 during initial assembly, with the container 8 in what is referred to herein as an open configuration of the container in which an upper extent 27 of the container side wall 12 extends generally vertically (e.g., longitudinally) to define an inner diameter slightly greater than the inner diameter of the lower extent 29 of the container side wall to define a shoulder 23 for longitudinally locating the sealing assembly 22 upon insertion of the sealing assembly 22 into the container 8. The inner diameter of the lower extent 29 of the container side wall 12 suitably corresponds to the inner diameter of the upper extent 27.

As shown in FIG. 1, the sealing assembly 22 is sized radially to have an outer diameter that is at least greater than the inner diameter of the lower extent 29 of the container side wall 12, and is more suitably approximately equal to the inner diameter of the upper extent 27 of the container in its open configuration. A tubular, thin-walled separator 20 is located on the inner diameter of the cathode 16. The separator comprises at least a first portion and a second portion. The first portion is disposed generally between the cathode 16 and the anode 18. The second portion extends longitudinally outward of the cathode 16 as shown in FIG. 1.

One example of a particularly suitable separator 20 is disclosed in U.S. patent application Ser. No. 10/914,934 and is a relatively thin film, such as having a thickness of less than or equal to about 250 microns. The separator film may even be as thin as about 5 microns to about 25 microns. However, it is understood that the separator 20 may be constructed of a paper material, a fibrous non-woven web or other conventional separator material or combinations thereof, and may have a thickness greater than 0.01 inches, without departing from the scope of this invention.

Another suitable separator material has a polymer backbone formed from a straight chain, a branched chain, or variants thereof. Examples of materials having such a backbone that have been found to provide a suitable separator include polyvinyl alcohol (PVA), poly (ethylene-co-vinyl alcohol—EVOR), copolymers of polystyrene, blends or co-extrusions of these and like materials with materials such as polyethylene, polypropylene, polystyrene, and variants of the foregoing. Additional suitable separator materials include cellulosic films such as cellophane and variants thereof. However, not all such polymers are suitable, particularly when used in cells where the cathode produces anode fouling soluble species. Rather, suitable polymers retain electrolyte in the separator where, in the separator, the retained electrolytes has a pH value lower than the bulk electrolyte found in the cathode and the anode. The separator-retained electrolyte desirably has a pH value that is 0.5 to 3 pH units lower than the pH of the bulk electrolyte. The extent to which electrolyte is retained in the separator, and the extent to which the pH of the retained electrolyte can vary from that of the bulk electrolyte, can be modulated by polymer side groups provided on the backbone. Alcohol side groups are suitable, ranging from simple hydroxyl groups to more complex side chains that comprise at least one alcohol moiety, including linear, cyclic and branched side chains that can comprise carbon, nitrogen, oxygen, sulfur, silicon, and the like. Other side groups such as carboxylic acid functional groups can be provided on the separator to enhance or inhibit electrolyte retention or pH in the separator. The separator is hydrated by the bulk alkaline aqueous electrolyte, as in conventional cells, but the electrolyte retained in the hydrated separator has a characteristic pH lower than that of the bulk electrolyte.

The separator can be a film and is optionally formed on the cathode or inserted into the cell during cell manufacture. A particularly suitable film has as small a cross-sectional thickness as is practical while retaining manufacturing processibility (e.g., flexibility, mechanical stability, integrity at processing temperatures, integrity within the cell, and the like), adequate electrolyte absorption, as well as the advantageous properties noted herein. Suitable dry film thicknesses typically range from about 10 to about 250 microns. Depending on the difference between the pH value of the bulk electrolyte and the pH value of the electrolyte retained in the separator, the thickness of a film separator may be selectively optimized to effectively limit the migration of anode-fouling soluble species. In an alternative embodiment of the present invention, the separator comprises a non-woven fabric coupled to a film, described in further detail below.

One version of the present invention includes a sealed separator system for an electrochemical cell that is disposed between a gelled zinc anode of the type described above and a cathode containing soluble species of copper, silver, sulfur, or combinations thereof, as described above. It should thus be appreciated that the term “sealed separator system” is used herein to define a structure that physically separates the cell anode from the cathode, enables hydroxyl ions and water to transfer between the anode and cathode, limits transport other than through the material itself by virtue of a seam and bottom seal, and effectively limits the migration through the separator of other soluble species such as copper, silver, nickel, iodate, and sulfur species from the cathode to the anode. It should be appreciated that the adhesives described herein are equally applicable to electrochemical cells that do not contain a “sealed separator system.” The choice of separator material and the need for a “sealed separator system” depends to some extent upon the cathode active material in the cell, and whether or not anode-fouling species are produced. In a conventional alkaline cell using a manganese dioxide cathode where no significant anode fouling species are produced, a film separator such as one made of polyvinyl alcohol or cellophane alone or in combination with a non-woven material may be used without a bottom or side seam seal so long as adequate measures are taken to prevent internal soft shorting by transport of fine particulates. The use of an adhesive such as described herein will effectively limit the crossover between the anode and cathode compartments over the top of the separator.

The utility of an alkaline electrochemical cell constructed in accordance with the principles of the present invention can be significantly enhanced by providing in the cell an improved barrier-separator system that effectively limits the migration of anode-fouling soluble species from the cathode into the anode compartment while permitting migration of hydroxyl ions. With certain cathode materials, such as CuO, CuS, CuAg₂O₄ and Cu₂Ag₂O₃, it is advantageous to use a separator system that employs a barrier to migration of the soluble species such as Cu, Ag, S, and the like, that are produced (migration reduced by at least about 50%; alternatively at least about 60%; finally at least about 70% in a test as described herein). Such barrier materials can include PVA (polyvinyl alcohol) films, modified or crosslinked PVA (polyvinyl alcohol) films, EVOH (ethyl vinyl alcohol), cellulose type films (e.g., cellophane and modified cellulose films), and laminated or non-laminated combinations or synthetic hybrids of such films. These materials enable a larger variety of oxides, sulfides, and metal complexes to be used as cathode active materials in accordance with aspects of the present invention to produce a battery with improved shelf life.

The separator can further have structure and conductivity enhancing agents incorporated therein. The separator can be a conformal separator for use in an electrochemical cell wherein the separator comprises materials that effectively limit (i.e., at least about 50%, alternatively at least about 60%; at least about 70%; and finally at least about 90%) the soluble species from passing there-through.

In accordance with various aspects of the present invention, several materials and combinations of materials have been found effective for alkaline cells having a gelled zinc anode and copper, silver and sulfur ions in the cathode. These materials were further evaluated to determine what material property effectively limited the migration of the anode-fouling soluble species.

A relatively high physical porosity in the form of open pores that extend through the separator from the anode side of the separator to the cathode side of the separator is undesirable in the separator of a cell where anode fouling species are present. For instance, cellophanes, PVA, EVOH, TiO₂-filled high molecular weight polyethylene (HMWPE) membranes, and the like are anticipated as being suitable separator materials. A HMWPE sample is available from Advanced Membrane Systems, located in Billerica, MA, and is a porous membrane that can be filled with TiO₂ to decrease the porosity and increase the tortuosity of the separator pores.

It has also been determined that PVA films or fabrics coated or impregnated with polymers such as PVA, EVA and EVOH (each of which may be cross-linked), herein defined as a “hybrid separator,” are effective in limiting the migration of anode-fouling soluble species if the porosity is minimized or eliminated.

While a non-woven fabric substrate coated, impregnated, or otherwise coupled with an appropriate polymer like PVA or EVA is effective in limiting Cu, Ag, and S migration, it is desirable to reduce the thickness of the material and also to form a relatively impervious film using such materials. In this regard, PVA film may be cast directly from a water-based solution on a substrate from which the dried film can be easily peeled off. For example, a 10% PVA solution (Celvol grade 350 PVA from Celanese Ltd., Dallas, Tex.) was cast on a Mylar substrate/release film at 70° C. Experiments per the prescribed Exclusion Test method show that the film possesses desirable barrier properties against migration of copper, silver and sulfur species. Commercially available PVA films have also been evaluated, showing similar trends. One example of a manufacturer of such PVA films is Monosol LLC located in Portage, Ind. Several samples from Monosol have been evaluated, some containing processing aids and/or plasticizers. The resistance of the films in concentrated potassium hydroxide has also been measured, showing that as the ability to effectively limit the migration of anode-fouling species improves, the ionic resistance increases. In general, PVA film samples containing significant amounts of plasticizer are less effective at limiting migration of soluble species while maintaining acceptably low ionic resistance. It may be appreciated by those skilled in the art, that effective limitation of the migration of soluble species can be attained by selecting the polymer properties, including the chemical composition, molecular weight, molecular weight distribution, additives and by appropriate cross-linking.

Those skilled in the art will appreciate that other polymer solutions may also be used to coat, impregnate, or otherwise couple non-woven or cellophane separators and achieve effects similar to those seen with PVA when used as a separator for electrochemical cells having a zinc anode and a cathode that contains anode-fouling soluble species. Alternatively, polymer solutions can coat the anode or cathode directly, thereby providing a conformal separator. It should thus be appreciated that many of the polymer solutions discussed below as forming part of a hybrid separator (e.g., a non-woven fabric separator coated or impregnated with the polymer) can alternatively be applied directly to the inner cathode surface or outer anode surface to provide a conformal separator that enables hydroxide ion transport while effectively limiting the migration of soluble copper, silver, and sulfur species. This type of separator can also minimize the need for a separate side seam or bottom seal.

Other such polymers are ethyl vinyl acetate (EVA) emulsion (that contains vinyl acetate monomers), vinyl acetate-ethylene copolymers and vinyl acetate polymers that can be coated or impregnated onto a non-woven separator to effectively limit the migration of anode-fouling soluble species such as, for example, copper, silver, sulfides, polysulfides, thiosulfates, sulfites, iodates, iodides, phosphates, silicates, or carbonates. Another suitable polymer is EVOH.

Organic or inorganic materials, such as Laponite®, Bentonite or smectite clays, or clay like materials, can also be incorporated into the polymer solutions to further enhance the performance of the polymer coated separator by providing structure or enhancing ion transport, ionic conductivity and absorption or adsorption of anode fouling species.

It has further been discovered that a separator can include a first group (Group I) of separator materials (e.g., cellophane, TiO₂ filled I-TM WPE, etc.) that more effectively limits the migration of the anode-fouling soluble copper and silver species in combination with a second group (Group II) of separator materials (e.g., PVA film or PVA coated on or impregnated in a non-woven separator, with or without cross-linking) that effectively limits the migration of the anode-fouling soluble sulfur species. The combination effectively limits soluble copper, Ag and sulfur species. The two separator materials can be stacked, laminated, or coated in various combinations. For instance, a Group I material can be coated onto an anode-facing or cathode-facing surface of a non-woven separator of Group II (or layers of suitable non-woven separators), or alternatively can be placed between adjacent layers of non-woven separator coated with PVA or a combination of suitable non-woven separators.

One measure of the suitability of a separator to effectively limit the migration of anode-fouling soluble species is the air permeability of the separator. Air permeability can be measured in Gurley seconds, as appreciated by one having ordinary skill in the art. Because the Gurley test measures the length of time necessary to pass a predetermined volume of air through a separator, a longer time measurement is an indication of low air permeability. A separator having a Gurley Number of 500 Gurley seconds or higher has been found suitable for use in an electrochemical cell described above. The Gurley measurement was taken using Model No. 4150N, commercially available from Gurley Precision Instruments, located in Troy, N.Y., at a pressure drop of about 31 centimeters of water to displace 10 cc air through a 1 sq. inch area. The higher the Gurley Number, the better. One having ordinary skill in the art will now recognize that a film separator having a relatively high Gurley Number will have few, if any, open pores.

It is to be appreciated that air permeability is not necessarily an accurate indicator of the permeability of the separator when wet with electrolyte containing the anode-fouling soluble species. Hence, a more direct measure of the suitability of a separator to effectively limit the migration of the anode-fouling soluble species is to use the results of a direct measurement analysis such as the Exclusion Test described below.

The separator is also compatible with known variations and improvements in cathode, anode and electrolyte structure and chemistry, but finds particular advantage for cells having a cathode that contains one or more cathode active materials comprising at least one of a primary oxide or sulfide of a metal, a binary oxide or sulfide of a metal, a ternary oxide or sulfide of a metal or a quaternary oxide or sulfide of a metal, where the metal is selected from manganese, copper, nickel, iron and silver, that can dissolve to form one or more anode-fouling soluble species, including but not limited to ionic metallic species and sulfur species, that can disadvantageously migrate from the cathode to the anode in the bulk electrolyte fluid in fluid communication with both the cathode and the anode. As used herein, “binary,” “ternary,” and “quaternary” refer to containing two, three or four of a particular species. Materials finding utility as cathode active materials include but are not limited to manganese dioxide, copper sulfide, copper oxide, copper hydroxide, nickel oxyhydroxide, silver oxides, copper iodate, nickel iodate, copper fluoride, copper chloride, copper bromide, copper iodide, copper silver oxides and copper manganese oxides, and combinations thereof. Combinations of cathode active materials can be provided in a cathode as mixtures or as separate entities.

It will be appreciated, however, that to the extent the anode active material of a cell tolerates the soluble species, the cell can tolerate some migration through the separator of anode-fouling soluble species. Generally, therefore, a suitable separator effectively limits the migration of anode-fouling soluble species if the separator passes less of the species than the anode active material can tolerate without becoming fouled. Substantially lower amounts of the soluble species are desired, however.

Also, a substantial portion of the electrolyte retained in the separator, for instance at least about 50%, is associated with (typically, non-covalently associated with) the polymer backbone or its side groups. A suitable measure of such an association is obtained by analyzing the separator material to determine the temperature at which water retained in the separator melts after freezing. Whereas free water retained in, but not physically associated with, the polymer melts at about 0° C., a lower melting temperature indicates an association with the polymer and, accordingly, a desirable separator. A suitable method for determining the temperature at which separator-retained water transitions to the liquid phase employs a simple differential scanning calorimetric (DSC) test. A suitably sized sample of the separator material is swollen in water for one hour then immersed in liquid nitrogen until frozen. The frozen sample is melted at a rate of 2° C. per minute in a low temperature DSC apparatus (commercially available from TA Instruments (Newark, DE)) and the melting temperature is observed at temperatures in the range of at least as low as about −30° C. to about 20° C. A suitable separator material in a cell also desirably transports water over hydroxide ions, and hydroxide ions to soluble species. This is an indication of “osmotic” transport.

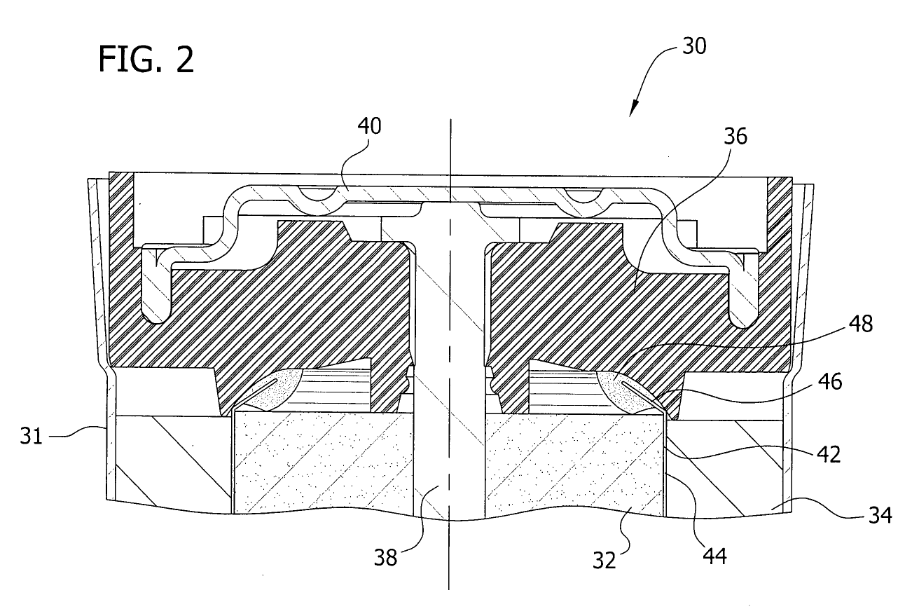

Referring now to FIG. 2, there is shown an electrochemical cell 30 having a container 31, an anode 32, a cathode 34, a sealing assembly 36, a negative current collector 38, negative terminal plate 40, and separator 42. In this embodiment, the separator 42 comprises a first portion 44 located between the anode 32 and the cathode 34, and a second portion 46 which extends longitudinally out of the anode 32 and cathode 34 and under the sealing assembly 36. Encapsulating and being mechanically bonded to the second portion 46 of separator 42 is adhesive material 48, which is also mechanically bonded to sealing assembly 36. By sealing the second portion 46 of the separator 42, this adhesive material 48 substantially minimizes or eliminates physical and chemical transport from the anode 32 to the cathode 34, and vice versa, which can result in fouling and a short circuit in the battery. The adhesive material 48 allows for the use of thin film separator materials (e.g., films or films coupled to a non-woven) which have been traditionally difficult to use effectively in combination with conventional compressed gasket systems due to the insufficient wet strength of the separator which compromises an effective seal that can prevent or minimize cross-transport of anode and cathode particles during handling, use, abuse, etc.

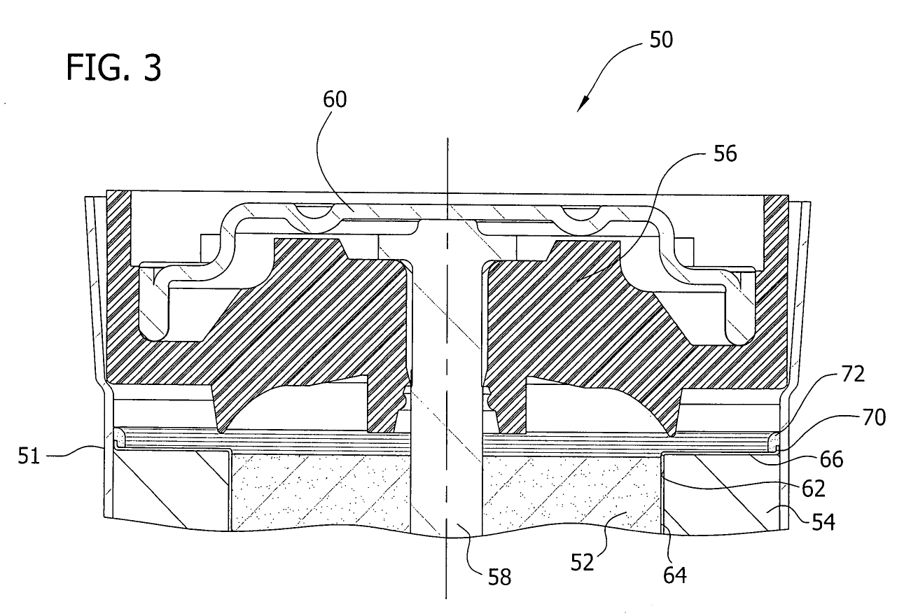

Referring now to FIG. 3, there is shown an electrochemical cell 50 having a container 51, an anode 52, a cathode 54, a sealing assembly 56, a negative current collector 58, negative terminal plate 60, and separator 62. In this embodiment, the separator 62 comprises a first portion 64 located between the anode 52 and the cathode 54, a second portion 66 located between adhesive material 72 and cathode 54, and a third portion 70l which extends longitudinally above cathode 54 and parallel to container 51. Mechanically bonded to the container 51 and to the third portion 70 of separator 62 is adhesive material 72. By sealing the third portion 70 of the separator 62, this adhesive material 72 substantially minimizes or eliminates physical and chemical transport from the anode 32 to the cathode 34, and vice versa, which can result in fouling and a short circuit in the battery. The adhesive material 72 allows for the use of thin film separator materials which have been traditionally difficult to use effectively as noted above.

The adhesive material utilized to bond or seal the separator with the sealing assembly and/or the container as described in the above embodiments is an adhesive material that is substantially chemically inert with respect to highly alkaline environments, such as those encountered with alkaline electrolytes, such as potassium hydroxide or sodium hydroxide. The adhesive material mechanically bonds the separator with the sealing assembly and/or the container, and substantially minimizes or eliminates any physical and/or chemical transport of species harmful to the anode/cathode from transporting over the top of the separator. Materials that have a high exclusion value against the fouling species noted herein would be applicable as an adhesive material if capable of being applied in appropriate locations. As such, materials based on ethyl vinyl acetate are suitable adhesives. Examples of commercially available vinyl acetate/ethylene copolymer emulsion adhesives include, for example, Airflex 323, Airflex 405, Airflex 426, and Airflex 920 carboxylated (Air Products and Chemicals, Inc. Allentown, Pa.). Although not required, it is generally preferable that the adhesive material be substantially or completely cured prior to any contact with the alkaline electrolyte to reduce or eliminate the potential for chemical interaction therebetween. Although any number of commercially available adhesive materials or epoxy materials could be used in accordance with the present invention, some specific adhesives include ethyl vinyl acetate polymers, vinyl acetate/ethylene copolymers, and combinations thereof. Other specific adhesive materials include those sold under the TRA-BOND trade name (TRA-CON, Bedford, Mass.), and include, for example, TRA-BOND 2129 and TRA-BOND 2101. Additionally, adhesives that possess high hydrophobicity are suitable adhesives and include for example, fluorinated polymers.

The adhesive materials used to form mechanical bonds with the separator to reduce unwanted physical and chemical transport and short circuits are substantially resistant to chemical attack by water and alkaline electrolytes such as potassium hydroxide, as noted above. Additionally, it is generally desirable that the adhesive material not substantially transmit copper, silver and/or sulfur species into the surrounding environment, as such species can negatively affect the life of the battery through anode fouling. Also, although not required, the adhesive material is desirably allowed to cure for a sufficient period of time to create a strong bond between components prior to use in the battery. Such curing allows the adhesive material to better withstand the highly alkaline environment of the electrochemical cell.

To finally assemble the electrochemical cell 2 illustrated in FIG. 1, the cathode 16, separator 20 and anode 18 are loaded into the container 8 with the container in its open configuration as shown in FIG. 1. The sealing assembly 22, negative current collector 24 and negative terminal plate 28 are placed in the open upper end of the container 8 with the sealing assembly 22 seating on the shoulder 23 formed at the junction of the upper and lower extents 27, 29 of the container and the negative terminal plate 28 seated on the shoulder formed in the sealing assembly 22.

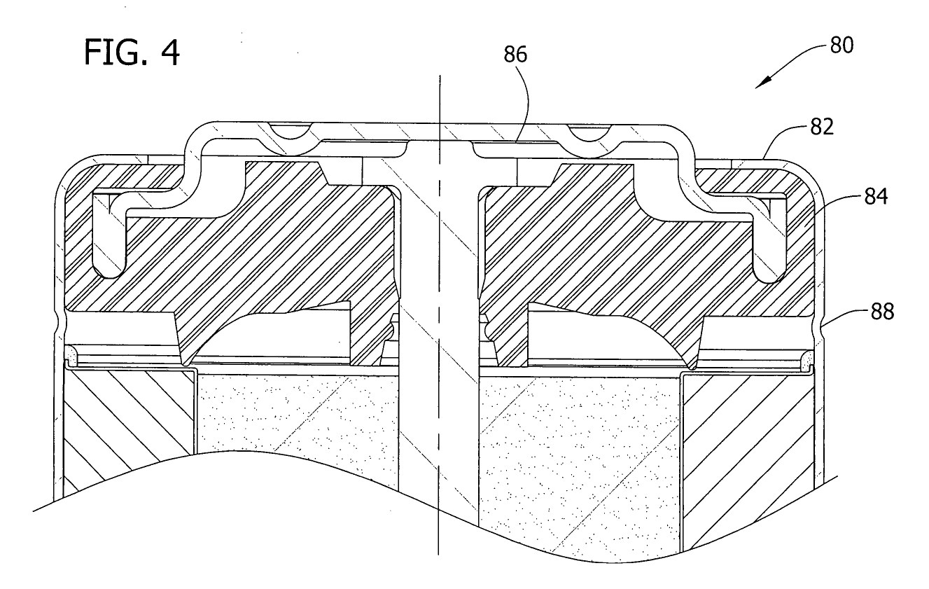

The upper extent 27 of the container side wall 12 is then bent inward, thereby bending the outer vertical leg of the outer portion 25 of the sealing assembly 22 over the outer edge of the negative terminal plate 28 to complete the assembly of the cell. In FIG. 4, there is shown an electrochemical cell 80 in a closed configuration; that is, the configuration after the cell has been loaded and sealed. As the upper extent 27 of the container side wall 12 is bent inward, the inner diameter of the upper extent 27 of the container side wall 12 becomes substantially equal to the inner diameter of the lower extent 29 of the container side wall 12. The upper extent 27 of the container side wall 12 thus applies a compressive (e.g., inward) force against the outer portion 25 of the sealing assembly 22 as the side wall diameter decreases. A downward compressive force is also applied against the inner portion of the sealing assembly 22. The inner flange is urged downwardly so that the spacing between the inner flange and the cathode 16 is less than the thickness of the separator 20 to thereby pinch (e.g., compress) the second portion of the separator between the anode 18 and the sealing assembly 22. It is contemplated that the spacing between the anode 18 and the inner flange in the closed configuration of the container 8 may be approximately equal to the thickness of the separator 20 (so as to hold the separator therebetween with little or no compression applied to the separator), or slightly greater than the thickness of the separator. In one embodiment of the present invention, the downward compression of the sealing assembly places the sealing assembly in contact with adhesive material.

Referring now to FIG. 4, there is shown an electrochemical cell 80 in a closed configuration; that is, the configuration after the cell has been loaded and sealed. As illustrated in FIG. 4, the upper extent portions of the container side wall 82 have been bent inward, thereby bending the outer vertical leg of the outer portion of the sealing assembly 84 over the outer edge of the negative terminal plate 86. Upon closing the container, an annular groove 88 is formed in the container as a result of the shoulder having been initially formed in the open configuration of the container.

Having described the invention in detail, it will be apparent that modifications and variations are possible without departing the scope of the invention defined in the appended claims. Furthermore, it should be appreciated that all examples in the present disclosure are provided as non-limiting examples.

### EXAMPLE

In this Example, the bonding ability of various commercially available adhesive materials were analyzed to determine the effect of curing time on the resulting bonding strength.

Three commercially available adhesive materials were prepared as directed: Loctite® 401 (available from Henkel Technologies, Rocky Hill, Conn.), TRA-BOND 2129 and TRA-BOND 2101 (both available from TRA-CON, Bedford, Mass.). Each adhesive material was applied on a sample sealing assembly at the area between the position of the separator and the negative current collector. A pre-cut, 1 cm height, PVA tube separator was inserted into the adhesive on the sealing assembly. After 1 hour of curing, the sealing assembly-separator was immersed in a solution of 7% potassium hydroxide electrolyte solution, and placed in a 60° C. oven for 4 days.

After 4 days, the bond strength was evaluated, and the results are displayed in Table 1, below.

TABLE 1

| Adhesive | Trial 1 | Trial 2 | Trial 3 |
|---|---|---|---|
| Loctite ® 401 | No Bond | No Bond | No Bond |
| TRA-BOND 2129 | Acceptable | Acceptable | No Bond |
| | Bonding | Bonding | |
| TRA-BOND 2101 | Acceptable | Acceptable | No Bond |
| | Bonding | Bonding | |

### Comparative Example

In this Example, TRA-BOND 2129 and TRA-BOND 2101 were prepared and tested as adhesives according to the process described in the above Example, however, in this Comparative Example, following insertion of the separator into the adhesive on the sample sealing assembly, the sealing assembly-separator was placed in a 60° C. oven overnight to fully cure.

After this overnight incubation, the sealing assembly-separator was immersed into a solution of 7% potassium hydroxide electrolyte solution, and placed in a 60° C. oven for 7 days.

After 7 days, the bond strength was evaluated, and the results are displayed in Table 1, below.

TABLE 2

| Adhesive | Trial 1 | Trial 2 | Trial 3 |
|---|---|---|---|
| TRA-BOND 2129 | Good | Good | Good |
| | Bonding | Bonding | Bonding |
| TRA-BOND 2101 | Good | Good | Good |
| | Bonding | Bonding | Bonding |

As illustrated by the above Examples, the TRA-BOND adhesive applications appear to be able to withstand a highly alkaline environment such as those of alkaline electrolyte solutions found in electrochemical seals. It also appears that the TRA-BOND adhesives require a more complete curing prior to being exposed to an alkaline solution.

What is claimed is:

1. An electrochemical cell comprising:
a cathode;
an anode;
a container containing the cathode and the anode;
a separator disposed in the container comprising a first portion and a second portion, the first portion being disposed generally between the cathode and the anode and the second portion extending longitudinally outward of the cathode and the anode; and
an adhesive material covering at least a part of the second portion of the separator, the adhesive material being capable of minimizing physical and chemical transport over the second portion of the separator.

2. The electrochemical cell as set forth in claim 1 wherein the adhesive material is in contact with the container.

3. The electrochemical cell as set forth in claim 1 further comprising a sealing assembly.

4. The electrochemical cell as set forth in claim 3 wherein the adhesive material is in contact with the sealing assembly.

5. The electrochemical cell as set forth in claim 1 wherein the adhesive material is an ethyl vinyl acetate polymer.

6. The electrochemical cell as set forth in claim 1 wherein the adhesive material is a vinyl acetate/ethylene copolymer.

7. The electrochemical cell as set forth in claim 1 wherein the adhesive material is a fluorinated polymer.

8. The electrochemical cell as set forth in claim 1 wherein the separator comprises a film.

9. The electrochemical cell as set forth in claim 1 wherein the separator comprises a film, the separator being configured such that substantially all fluid communication between the anode and the cathode occurs through the separator.

10. The electrochemical cell as set forth in claim 1 wherein the separator comprises a non-woven material.

11. The electrochemical cell as set forth in claim 1 wherein the separator comprises a non-woven fabric coupled to a film.

12. The electrochemical cell as set forth in claim 1 wherein the separator comprises a polymeric material.

13. The electrochemical cell as set forth in claim 12 wherein the polymeric material is selected from the group consisting of polyvinyl alcohol, polyethylvinyl alcohol, cellophane, and combinations thereof.

14. The electrochemical cell as set forth in claim 1 further comprising an alkaline electrolyte in fluid communication with the separator.

15. The electrochemical cell as set forth in claim 14 wherein the alkaline electrolyte is potassium hydroxide.

16. An electrochemical cell comprising:
a cathode;
an anode;
a negative current collector disposed in the container and in contact with the anode;
a container containing the cathode and the anode;
a separator disposed in the container comprising a first portion and a second portion, the first portion being disposed generally between the cathode and the anode and the second portion extending longitudinally outward of the cathode; and
an adhesive material in contact with the container and covering at least a part of the second portion of the separator, the adhesive material being capable of minimizing physical and chemical transport over the second portion of the separator.

17. The electrochemical cell as set forth in claim 16 wherein the adhesive material is an ethyl vinyl acetate polymer.

18. The electrochemical cell as set forth in claim 16 wherein the adhesive material is a vinyl acetate/ethylene copolymer.

19. The electrochemical cell as set forth in claim 16 wherein the adhesive material is a fluorinated polymer.

20. The electrochemical cell as set forth in claim 16 wherein the separator comprises a film.

21. The electrochemical cell as set forth in claim 16 wherein the separator comprises a film, the separator being configured such that substantially all fluid communication between the anode and the cathode occurs through the separator.

22. The electrochemical cell as set forth in claim 16 wherein the separator is a non-woven material.

23. The electrochemical cell as set forth in claim 16 wherein the separator comprises a non-woven fabric coupled to a film.

24. The electrochemical cell as set forth in claim 16 wherein the separator comprises a polymeric material.

25. The electrochemical cell as set forth in claim 24 wherein the polymeric material is selected from the group consisting of polyvinyl alcohol, polyethylvinyl alcohol, cellophane, and combinations thereof.

26. The electrochemical cell as set forth in claim 16 further comprising an alkaline electrolyte in fluid communication with the separator.

27. The electrochemical cell as set forth in claim 26 wherein the alkaline electrolyte is potassium hydroxide.

28. An electrochemical cell comprising:
a cathode;
an anode;
a negative current collector disposed in the container and in contact with the anode;
a container containing the cathode and the anode;
a sealing assembly;
a separator disposed in the container comprising a first portion and a second portion, the first portion being disposed generally between the cathode and the anode and the second portion extending longitudinally outward of the cathode and the anode; and
an adhesive material in contact with the sealing assembly and covering at least a part of the second portion of the separator, the adhesive material being capable of minimizing physical and chemical transport over the second portion of the separator.

29. The electrochemical cell as set forth in claim 28 wherein the adhesive material is an ethyl vinyl acetate polymer.

30. The electrochemical cell as set forth in claim 28 wherein the adhesive material is a vinyl acetate/ethylene copolymer.

31. The electrochemical cell as set forth in claim 28 wherein the adhesive material is a fluorinated polymer.

32. The electrochemical cell as set forth in claim 28 wherein the separator comprises a film.

33. The electrochemical cell as set forth in claim 28 wherein the separator comprises a film, the separator being configured such that substantially all fluid communication between the anode and the cathode occurs through the separator.

34. The electrochemical cell as set forth in claim 28 wherein the separator comprises a non-woven material.

35. The electrochemical cell as set forth in claim 28 wherein the separator comprises a non-woven fabric coupled to a film.

36. The electrochemical cell as set forth in claim 28 wherein the separator comprises a polymeric material.

37. The electrochemical cell as set forth in claim 36 wherein the polymeric material is selected from the group consisting of polyvinyl alcohol, polyethylvinyl alcohol, cellophane, and combinations thereof.

38. The electrochemical cell as set forth in claim 28 further comprising an alkaline electrolyte in fluid communication with the separator.

39. The electrochemical cell as set forth in claim 38 wherein the alkaline electrolyte is potassium hydroxide.
